(19) United States
(12) Patent Application Publication
(10) Pub. No.: US 2006/0168653 A1
(43) Pub. Date: Jul. 27, 2006

(54) Personal network security token

(76) Inventor: Suzanne Hall Contrera, Rockville, MD (US)

Correspondence Address: THE LAW OFFICE OF JOSEPH G. CONTRERA, ESQ., 15004 BITTEROOT WAY, ROCKVILLE, MD, 20853, US

(21) Appl. No.: 11/044,893

(22) Filed: Jan. 27, 2005

(51) Int. Cl. H04L 9/32

(52) U.S. Cl. 726/9

(57) ABSTRACT

In general the present invention provides for a small hand held size device that is easily kept in a pocket or purse or on a key chain. The security token will contain a microprocessor having memory function and will connect to a PC or other computing device or workstation via a USB port. Upon insertion into the open USB port of the user's remote computer, the personal network security token scans the remote computer to detect the presence of at least one or more operating applications, such as the type of anti-virus software and patch level and/or the type of operating system (OS) the remote computer is running and the patch level. Upon contacting the target network, the network will send an inquiry to the user's remote computer to determine if the personal network security token is present as well as other parameters. If the condition status of the token is “OK” then the network sends an authentication page to the user for the user to enter his or her user ID and password. If the ID and password are valid, then the user is allowed access to the network.

This patent application claims priority to U.S. patent application Ser. No. 60/______ filed Jan. 27, 2004, and is incorporated by reference herein as if set forth in its entirety.

### BACKGROUND OF THE INVENTION

1. Field of Invention

This invention relates to the field of secure data processing systems. More particularly, this invention relates to two factor security systems and a user possessing a security token to allow a remote user access to a network.

2. Description of Prior Art

In the last decade, the use of personal computers in both the home and in the office has become widespread. These computers provide a high level of functionality to many people at a moderate price, substantially surpassing the performance of the large mainframe computers of only a few decades ago. The trend is further evidenced by the increasing popularity of laptop and notebook computers, which provide high-performance computing power on a mobile basis.

Various measures have been proposed in the past to provide security in numerous applications in which it is necessary or desirable to limit access to a system or network. Passwords, for example, have been widely used to guard authorized access to computer networks and data. However, password verification schemes are most reliable when the password is manually entered and are not as effective when human interaction cannot be guaranteed. In other arrangements, electronic keys or tokens are used. Possession of the key or token identifies a user as being a valid user. The lack of possession of such a key or token would indicate that the user is not who he claims to be and he is denied use of the device. However, this arrangement is subject to unauthorized access occurring if an unauthorized user gains possession of the key or token.

Increasingly, so called “smart cards” are used for a variety of purposes. A “smart card” is typically a credit card sized card that has a built-in microcontroller that enables the card to provide, modify or even create data in response to external stimuli. In many instances, the microcontroller is a single wafer integrated circuit that is mounted on an otherwise plastic credit card or more recently in a USB compliant device.

### SUMMARY OF THE INVENTION

The present invention satisfies all of these needs with a personal security token in a form that is compliant with a commonly available I/O interface such as the Universal Serial Bus (USB). The personal security token includes a processor and separate memory, which implements software to verify the presence of anti-viral software and patch level, operating system and patch level and any other necessary application verification.

The present invention comprises a two-factor security token that can be carried by a user and allows a user to connect to a remote host computer via the Internet or VPN. The user can connect a security token or device to his local computer or workstation and the token scans the user s local computer or workstation to verify that the computer has the correct and latest version of an authorized anti-virus application plus scan the computer for the correct OS version and patch level. Once verified, the user would access the remote host and the host is able to identify the token on the user s computer and authenticate the user s token status. If the status is OK the user is allowed access to the remote host computer and/or network after the user entered the correct username and password.

### BRIEF DESCRIPTION OF THE DRAWINGS

FIG. 1 shows a process schematic of the preferred embodiment the invention.

FIG. 2 shows a schematic of an alternate embodiment of the invention.

### DETAILED DESCRIPTION AND PREFERRED EMBODIMENTS

The following description sets forth a specific embodiment of a system and procedure that incorporates elements recited in the appended claims. The embodiment is described with specificity in order to meet statutory requirements. However, the description itself is not intended to limit the scope of this patent. Rather, the inventors have contemplated that the claimed subject matter might also be embodied in other ways, to include different elements or combinations of elements similar to the ones described in this document, in conjunction with other present or future technologies.

In general, the present invention provides for a small hand held size device that is easily kept, for example, in a pocket, purse, on a key chain, etc. The device contains a security token which, in one embodiment, contains a microprocessor, at least one memory device operatively coupled to the microprocessor, and an interface such as a USB port for communicating with a PC or other computing device or workstation. U.S. Pat. No. 6,671,808 to Abbot et al. shows a similar device for use in verifying computer software certificates and is herein incorporated by reference in its entirety.

Universal Serial Bus (USB) is a standard peripheral interface for attaching personal computers to a wide variety of devices: e.g., digital telephone lines, monitors, modems, mice, printers, scanners, game controllers, keyboards, and other peripherals. In accordance with USB, all attached devices connect to a personal computer through a single connector type using a tiered-star topology. A host personal computer includes a single USB controller. The host controller provides the interface between the USB network and the host personal computer. The host controller controls all accesses to USB resources and monitors the bus's topology. A USB hub provides USB attachment points for USB devices. Similar keys are found today to verify software licenses on the users own machine, see TNT Software license keys from Microimages Inc., Lincoln Nebr. 68508-2010.

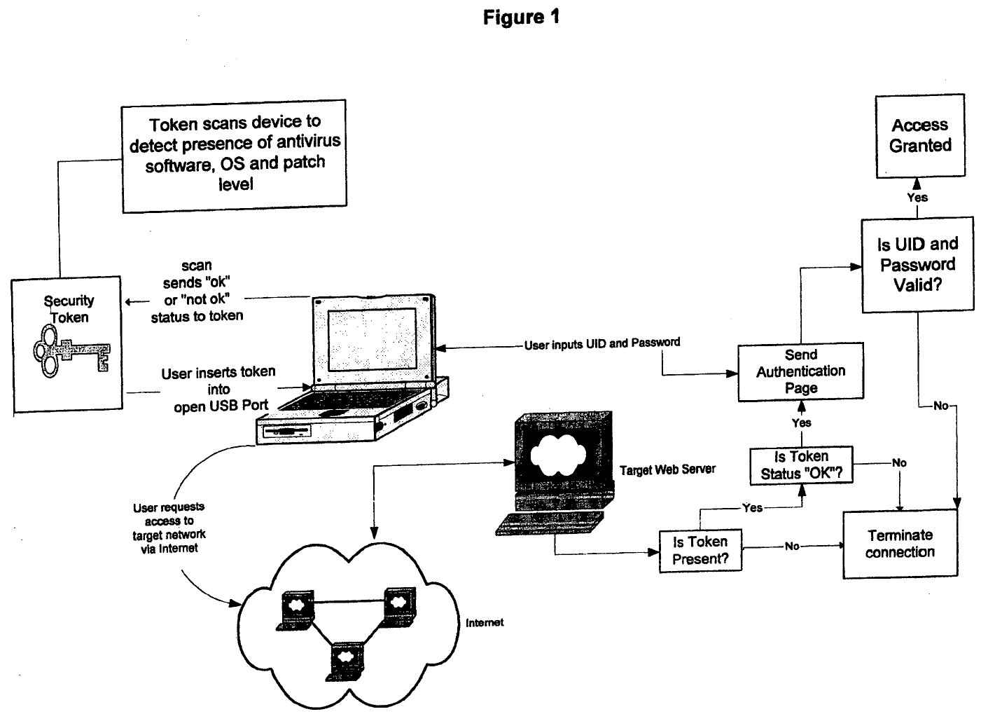

One embodiment of the present invention is described below with reference to the exemplary operational process illustrated in FIG. 1. The personal network security token is a device that is resident on a smart card or similar device. In a preferred embodiment, the security token smart card resides on a USB-compliant device or platform similar to the one described by Abbot et al. above. On the security token device, an EPROM or similar software memory device is programmed to the following steps:
1) Upon insertion into an open USB port of the user's remote computer, the personal network security token scans the remote computer to detect the presence of at least one or more applications that is/are currently executing on the remote computer. In a preferred embodiment, the security token will detect the type of anti-virus software and patch level. In a more preferred embodiment, the security token will detect the type of operating system (OS) the remote computer is running and the patch level. It is contemplated that any number of applications or devices could be detected with the security token and one skilled in the art would be able to add software to the security token to add or remove as many scan targets as needed; and
2) After completing the scan, the personal network security token sets a condition of “OK” or “NOT OK” depending on the parameters set in the device software. For example, in a preferred embodiment, the personal network security token scans the user's remote computer for the correct anti-viral software and patch level and finds that it is acceptable, and scans the computer for the OS and patch level and finds that acceptable as well, then the security token will set an “OK” condition. It is contemplated that the token is not limited to the terms “OK” or “NOT OK” and any means of identifying to the network the status of the user on the network.

In operation, the user attempts to access the target remote network via a phone line or cable line or Ethernet connection or possible via a wireless connection through the internet. This may be done as soon as the personal network security token is inserted into the computer. Upon contacting the target network, the network will send an inquiry to the user's remote computer to determine if the personal network security token is present on the user's computer, for example, in a USB port. If the personal network security token is not present during communication, the network denies access. If the personal network security token is present on the user's remote computer, than the network sends a second inquiry to the personal network security token to check the condition status of the token. If the condition status is “NOT OK” then the network again denies access. If the condition status of the token is “OK” then the network sends an authentication page to the user for the user to enter his or her user ID and password. If the ID and password are valid, then the user is allowed access to the network.

It is apparent that the personal network security token provides very good two-tier security in that the token must be present during access to the network and the condition must stay OK for the user to remain connected to the network. In a preferred embodiment, the network will periodically “ping” the personal network security token to make sure the token is still present and “OK” for the user to continue to have access to the network.

It is contemplated that in another embodiment, the personal network security token could be used to provide a user with permissions to access different levels of a network or allow users access only to certain resources within a target network based on the token.

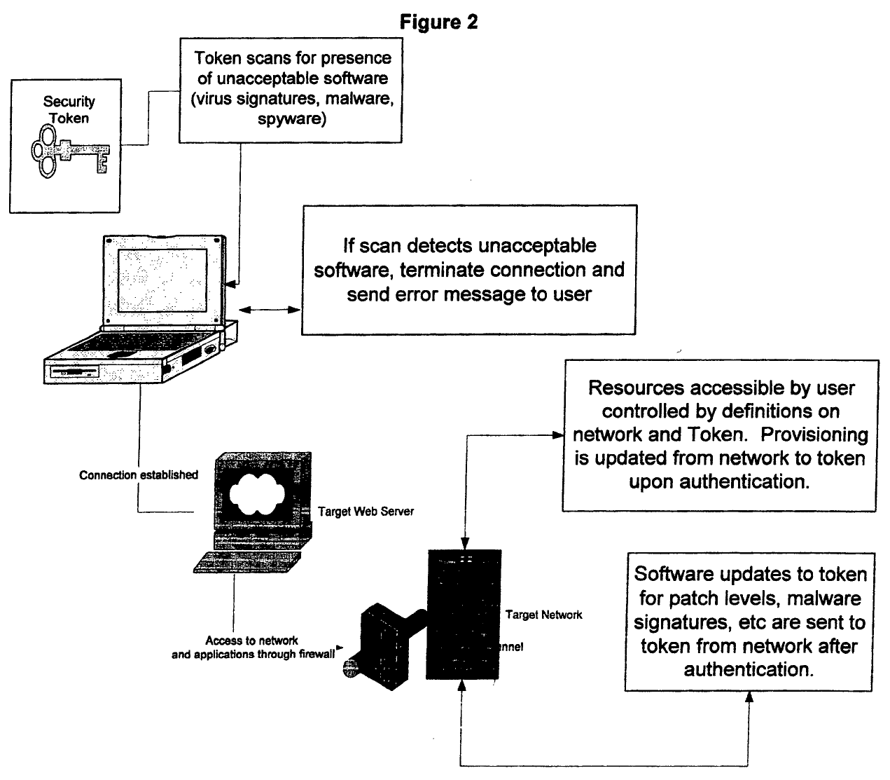

FIG. 2 shows how in an alternate embodiment, in addition to the personal network security token scanning the user's remote computer for the correct software, there are various additional security status conditions that can be programmed onto the token. In FIG. 2, after successful user ID and password logon, the target network will then ping the token for network access level. Then token will respond to the request with the access level that was programmed in by the target network security personnel either directly or via a remote reprogramming method. Once the target network receives the access level, it will allow the user to communicate with the network at that access level.

One of skill in the art can appreciate that the personal network security token could be programmed to scan the user's remote computer for the presence of other applications running that could present a threat to the security of the network, such as “spyware” or “PC anywhere” applications. Furthermore, the personal network security token could check the remote computer for correct device/hardware configurations as well.

In another preferred embodiment, the personal network security token is capable of being programmed remotely from the target network. Once a user is authenticated during a network logon, if the network has updated its software requirements or parameters, it can remotely upload new programming code from the target network into the personal network security token through the remote user's computer.

Having described the invention, many modifications thereto will become apparent to those skilled in the art to which it pertains without deviation from the spirit of the invention as defined by the scope of the appended claims.

The disclosures of U.S. Patents, patent applications, and all other references cited above are all hereby incorporated by reference into this specification as if fully set forth in its entirety.

1. A personal network security token for use in a remote computer, such as a PC, comprising a processor, separate memory, and software capable of collecting information about at least one application operating on the remote computer and patch level of said application, and said network security token also capable of communicating with a host computer through a network, wherein said network will detect said token and receive information from said token.

2. A personal network security token for use in a remote computer, comprising:
a) a processor;
b) non-volatile memory; and
c) software;
wherein said software is capable of collecting information about at least one application operating on the remote computer, and
said network security token is also capable of communicating with a host computer through a network or other electronic means,
wherein said host computer will receive information from said token and set a access level for the remote computer to the host computer via the network.

3. The personal network security token of claim 2, wherein
a) the security token resides on a USB-compliant device or platform;
b) the security token device further comprises an EPROM or similar memory device;
c) said memory device is programmed to perform the following steps:
i) Upon insertion into an open USB port of the user's remote computer, the personal network security token scans the remote computer to detect the presence of at least one or more applications that is/are currently executing on the remote computer and store this information in its memory;
ii) After completing the scan, the personal network security token sets a access condition in its memory depending on the parameters set in the token software; and
iii) when said remote computer accesses a target host computer through a network, said security token will communicate the information stored in its memory regarding at least one applications currently operating on the remote computer to the host computer.

4. A method for setting network access to a remote computer from a host computer comprising:
a) inserting of the network security token into the remote computer;
b) contacting the target host computer through a network via a phone, cable, Ethernet, or a wireless connection through the internet; and
c) logging into the target network;
wherein after completing steps a-c above, the host computer will perform the following steps:
d) communicating to the remote computer;
e) determining if the personal network security token is present on the remote computer;
f) checking the access condition of the personal network security token; and
g) allowing access to the host computer based on the access condition of the security token.

5. The security token of claim 3 wherein said token memory is programmed to detect one or more of the following types of applications: Operating system, firewalls, anti-virus software, remote access software, spyware, and anti-spyware.

6. The security token of claim 5 wherein said token memory collects information on applications including version, patches and installation dates.
